(19) United States
(12) Patent Application Publication
(10) Pub. No.: US 2021/0076229 A1
(43) Pub. Date: Mar. 11, 2021

(54) EXECUTING ANALYSIS AND MANAGEMENT OF A MOBILE COMMUNICATION NETWORK BASED ON PERFORMANCE INFORMATION, CONFIGURATION INFORMATION AND ENVIRONMENTAL INFORMATION

(71) Applicant: Nokia Technologies Oy, Espoo (FI)

(72) Inventor: Peter M. Rost, Heidelberg (DE)

(21) Appl. No.: 16/756,485

(22) PCT Filed: Oct. 19, 2017
(86) PCT No.: PCT/EP2017/076740

§ 371 Date: Apr. 16, 2020

(51) Int. Cl. H04W 24/02; H04W 24/08; H04L 12/24; H04L 29/08; H04Q 9/00; G06N 20/00

(52) U.S. Cl. CPC H04W 24/02; H04W 24/08; H04L 41/0803; H04Q 2209/40; H04L 67/12; H04Q 9/00; G06N 20/00; H04L 41/14

(57) ABSTRACT

An apparatus for use by a control element or function configured to execute a communication network analysis and management, the apparatus comprising at least one processing circuitry, and at least one memory for storing instructions to be executed by the processing circuitry, wherein the at least one memory and the instructions are configured to, with the at least one processing circuitry, cause the apparatus at least: to receive, from at least one communication network control element or function of a mobile communication network, and store performance information indicating a communication performance in the mobile communication network measured at the at least one communication network control element or function, to receive and store configuration information indicating configuration parameters for the mobile communication network, to receive, from at least one sensor configured to measure an environmental parameter, and store environmental information indicating a result of an environmental parameter measurement, the environmental parameter measurement being different to a measurement conducted by the at least one communication network control element or function, to conduct a processing for correlating the performance information, the configuration information and the environmental information for analyzing an impact of the environmental parameter on the communication performance in the mobile communication network, and to decide, on the basis of a result of the processing for correlating, about at least one measure to be conducted in the mobile communication network for modifying a setting of the mobile communication network.

### BACKGROUND

### Field

The present invention relates to apparatuses, methods, systems, computer programs, computer program products and computer-readable media usable for analyzing and managing a communication network in order to improve robustness of the communication network.

### Background Art

The following description of background art may include insights, discoveries, understandings or disclosures, or associations, together with disclosures not known to the relevant prior art, to at least some examples of embodiments of the present invention but provided by the invention. Some of such contributions of the invention may be specifically pointed out below, whereas other of such contributions of the invention will be apparent from the related context.

The following meanings for the abbreviations used in this specification apply:

3GPP: 3^{rd} Generation Partner Project

AGV: automated guided vehicle

BS: base station

CN: core network

CPU: central processing unit

D-SON: distributed self organizing network

EM: element manager

eNB: evolved node B

ETSI European Telecommunications Standards Institute

HOF: handover failure

ID: identification, identifier

LTE: Long Term Evolution

LTE-A: LTE Advanced

MCS: modulation and coding scheme

NM: network manager

RLF: radio link failure

SNR: signal to noise ration

SON: self organizing network

UE: user equipment

UMTS: universal mobile telecommunication system

Embodiments of the present invention are related to a mechanism which allows to improve the robustness of a mobile communication network by conducting an analysis of conditions under which the communication is executed and by determining how changes in the conditions impact on the communication performance so as to be able to react in a suitable manner.

### SUMMARY

According to an example of an embodiment, there is provided, for example, an apparatus for use by a control element or function configured to execute a communication network analysis and management, the apparatus comprising at least one processing circuitry, and at least one memory for storing instructions to be executed by the processing circuitry, wherein the at least one memory and the instructions are configured to, with the at least one processing circuitry, cause the apparatus at least: to receive, from at least one communication network control element or function of a mobile communication network, and store performance information indicating a communication performance in the mobile communication network measured at the at least one communication network control element or function, to receive and store configuration information indicating configuration parameters for the mobile communication network, to receive, from at least one sensor configured to measure an environmental parameter, and store environmental information indicating a result of an environmental parameter measurement, the environmental parameter measurement being different to a measurement conducted by the at least one communication network control element or function, to conduct a processing for correlating the performance information, the configuration information and the environmental information for analyzing an impact of the environmental parameter on the communication performance in the mobile communication network, and to decide, on the basis of a result of the processing for correlating, about at least one measure to be conducted in the mobile communication network for modifying a setting of the mobile communication network.

Furthermore, according to an example of an embodiment, there is provided, for example, a method for use by a control element or function configured to execute a communication network analysis and management, the method comprising receiving, from at least one communication network control element or function of a mobile communication network, and storing performance information indicating a communication performance in the mobile communication network measured at the at least one communication network control element or function, receiving and storing configuration information indicating configuration parameters for the mobile communication network, receiving, from at least one sensor configured to measure an environmental parameter, and storing environmental information indicating a result of an environmental parameter measurement, the environmental parameter measurement being different to a measurement conducted by the at least one communication network control element or function, conducting a processing for correlating the performance information, the configuration information and the environmental information for analyzing an impact of the environmental parameter on the communication performance in the mobile communication network, and deciding, on the basis of a result of the processing for correlating, about at least one measure to be conducted in the mobile communication network for modifying a setting of the mobile communication network.

According to further refinements, these examples may include one or more of the following features:
the performance information indicating the communication performance in the mobile communication network may be related to at least one of a throughput at a communication network control element or function of the communication network, a packet loss rate, a handover failure, a radio link failure, a radio power receive level, and a traffic load, and the configuration information indicating the configuration parameters for the communication network may be related to at least one of a transmit power used for a communication with the communication network control element or function, a radio resource allocation, a handover threshold, a number of user allocations to the communication network control element or function, and a type of user allocations to the communication network control element or function;
the environmental information indicating the result of an environmental parameter measurement may comprise at least one of still picture data, moving image data, ultrasonic measurement data, radar measurement data, infrared measurement data, and measurement data analysis results;
the processing for correlating the performance information, the configuration information and the environmental information for analyzing the impact of the environmental parameter on the communication performance in the mobile communication network may be based on a machine learned decision logic for predicting an effect of an environmental parameter or a change of an environmental parameter on the communication performance in the mobile communication network, wherein the machine learned decision logic may be based on at least one of a Bayesian classifier, a linear classifier, a decision tree and a neural network;
at least one decision parameter in the decision logic may be set on the basis of an analysis of the environmental information, a set of attributes derived from the performance information, the configuration information and the environmental information may be classified in accordance with the at least one decision parameter, and the measure to be conducted in the mobile communication network for modifying a setting of the mobile communication network may be determined on the basis of the classification;
a training processing for adjusting the decision logic may be executed, wherein the training processing may include: receiving performance information, configuration information and environmental information, classifying a set of training attributes derived from the received performance information, configuration information and environmental information, comparing the result of the classifying of training attributes with pre-stored data, and adjusting settings of the decision logic on the basis of the comparison, wherein the training processing may be conducted for at least one of a predetermined time, a predetermined number of performance information, and a predetermined number of environmental information, and wherein the decision logic resulting from the training processing may be used for an operation of the apparatus;
the classifying may be related to at least one of an action to be required in the mobile communication network or an event which potentially occurs in the mobile communication network;
as the measure to be conducted in the mobile communication network for modifying the setting of the mobile communication network, a measure may be selected which is assumed to compensate or mitigate an effect of the environmental parameter on the communication performance of the mobile communication network, wherein the measure to be conducted may include at least one of adding additional communication resources to the communication, reserving additional communication resources for the communication, modifying a modulation and coding scheme used in the communication, preparing or instructing a handover of a communication element in the mobile communication unit, changing a communication mode used for the communication, and starting load balancing or cell breathing algorithms for the communication;
when it is decided to conduct at least one measure in the mobile communication network for modifying a setting of the mobile communication network, information about the performance information, the configuration information, the environmental information used in the processing for correlating, the decided measure to be conducted and performance information received after the measure to be conducted is effected may be recorded.

Furthermore, according to an example of an embodiment, there is provided, for example, a system for executing a communication network analysis and management, the system comprising at least one communication network control element or function of a mobile communication network, being configured to measure and provide performance information indicating a communication performance in the mobile communication network and to obtain and provide configuration information indicating configuration parameters for the mobile communication network, at least one sensor configured to measure an environmental parameter and to provide environmental information indicating a result of an environmental parameter measurement, the environmental parameter measurement being different to a measurement conducted by the at least one communication network control element or function, and an apparatus for use by a control element or function configured to execute a communication network analysis and management according to the above described apparatus.

According to further refinements, this examples may include one a features that the at least one sensor may be configured to provide, as the environmental information indicating the result of an environmental parameter measurement at least one of still picture data, moving image data, ultrasonic measurement data, radar measurement data, infrared measurement data, and measurement data analysis results.

In addition, according to embodiments, there is provided, for example, a computer program product for a computer, including software code portions for performing the steps of the above defined methods, when said product is run on the computer. The computer program product may include a computer-readable medium on which said software code portions are stored. Furthermore, the computer program product may be directly loadable into the internal memory of the computer and/or transmittable via a network by means of at least one of upload, download and push procedures.

### BRIEF DESCRIPTION OF THE DRAWINGS

Some embodiments of the present invention are described below, by way of example only, with reference to the accompanying drawings, in which:

FIG. 1 shows a diagram illustrating a configuration of a system for analyzing and managing a communication network according to some examples of embodiments of the invention;

FIG. 2 shows a signaling diagram illustrating an example for a processing being executed in a system for analyzing and managing a communication network according to some examples of embodiments of the invention;

FIG. 3 shows a signaling diagram illustrating an example for a processing being executed in a system for analyzing and managing a communication network according to some examples of embodiments of the invention;

FIG. 4 shows a flow chart of a processing for communication network analysis and management according to some examples of embodiments; and

FIG. 5 shows a diagram of a network element or function acting as a controller entity or function for use in a communication network analysis and management according to some examples of embodiments.

### DESCRIPTION OF EMBODIMENTS

In the last years, an increasing extension of communication networks, e.g. of wire based communication networks, such as the Integrated Services Digital Network (ISDN), DSL, or wireless communication networks, such as the cdma2000 (code division multiple access) system, cellular 3^{rd} generation (3G) like the Universal Mobile Telecommunications System (UMTS), fourth generation (4G) communication networks or enhanced communication networks based e.g. on LTE or LTE-A, fifth generation (5G) communication networks, cellular 2^{nd} generation (2G) communication networks like the Global System for Mobile communications (GSM), the General Packet Radio System (GPRS), the Enhanced Data Rates for Global Evolution (EDGE), or other wireless communication system, such as the Wireless Local Area Network (WLAN), Bluetooth or Worldwide Interoperability for Microwave Access (WiMAX), took place all over the world. Various organizations, such as the European Telecommunications Standards Institute (ETSI), the 3^{rd} Generation Partnership Project (3GPP), Telecoms & Internet converged Services & Protocols for Advanced Networks (TISPAN), the International Telecommunication Union (ITU), 3^{rd} Generation Partnership Project 2 (3GPP2), Internet Engineering Task Force (IETF), the IEEE (Institute of Electrical and Electronics Engineers), the WiMAX Forum and the like are working on standards or specifications for telecommunication network and access environments.

Generally, for properly establishing and handling a communication connection between two or more end points (e.g. communication stations or elements, such as terminal devices, user equipments (UEs), or other communication network elements, a database, a server, host etc.), one or more network elements such as communication network control elements, for example access network elements like access points, radio base stations, relay stations, eNBs, gNBs etc., and core network elements or functions, for example control nodes, support nodes, service nodes, gateways etc., may be involved, which may belong to one communication network system or different communication network systems.

A current development in new mobile communication networks, such as 5G network deployments, is the provision of so called “vertical use cases”. That is, besides the possibility to be used as a general purpose connectivity platform with limited differentiation capabilities across use cases, communication networks like 5G networks create an ecosystem for technical and business innovation involving vertical markets. For example, enterprise customers can deploy and operate dedicated purpose networks using mobile network technologies. Corresponding use cases are for example logistics, airports, harbors, process automation (chemical plants, oil & gas refineries, etc), automotive, energy, food and agriculture, city management, government, healthcare, manufacturing, public transportation, and the like.

By means of these use cases, it is possible to serve a larger variety of applications. However, there is also a multiplicity of requirements ranging from high reliability to ultra-low latency going through high bandwidth and mobility.

Hence, key performance indicators for corresponding implementations are reliability and deterministic latency, whereby it has to be noted that high reliability is a requirement for deterministic latency.

In typical enterprise deployments as mentioned above, deterministic (i.e. predictable) behaviour is of high importance. Therefore, sudden changes of the mobile network performance may have a severe impact on the operational performance of the enterprise.

Usually, changes in the mobile network performance are caused by various items, such as user mobility, a mobility (i.e. movement) in the vicinity of the user, and other environmental changes (e.g. weather condition). Such changes can cause a deterioration of the communication performance in the communication network, e.g. due to fading.

Assuming an ideal case where the conditions in the communication network are static. In other words, effects like fast or slow scale fading (e.g. Rayleigh fading and Shadowing, respectively) are not experienced. In such a case, the communication system could be configured and dimensioned once, and its performance is perfectly predictable because it is time-invariant. However, in reality, user mobility as well as mobility or movement within the vicinity of a user terminal like a UE communicating in the network may cause time-variant radio conditions. This would cause changes of the small-scale fading, which is typically referred to as Rayleigh fading where a large number of sufficiently independent radio waves superimpose at the UE, wherein due to the user's mobility such a superposition changes, e.g. depending on the user's velocity. In addition, mobility or movement in the vicinity of the UE or a BS communicating with the UE may cause similar changes. In addition, own mobility and mobility of other users may cause changes of the shadowing, i.e. an average attenuation of radio waves is changed. Similarly, changes of other environmental conditions may cause changes of the fast and small scale fading. As a result of such time-variant conditions, effects like unexpected handover events, packet losses, etc. may occur. In view of the high importance of predictable behaviour, which may by present for such vertical use cases for enterprise deployed networks, this situation may not acceptable.

Hence, it is a basic objective problem of the invention to provide a mechanism allowing to increase reliability of communication networks in view of the unpredictable nature of a radio channel.

According to examples of embodiments of the invention, an apparatus for a controller, a corresponding method and a system are provided which enable an improved network analysis and management for providing a highly reliable mobile network operation e.g. in localized enterprise networks.

Specifically, examples of embodiments of the invention consider the impact of extrinsic events causing changes of the mobile network performance and provide means allowing to detect and analyze such events in information domains being different to that used in communication network management in order to predict and instruct measures being able to compensate or mitigate such impacts. In other words, it is possible to correlate those events with mobile network performance changes in order to take early measures for compensation or the like.

In the following, different exemplifying embodiments will be described using, as an example of a communication network to which the embodiments may be applied, a communication network architecture based on 3GPP standards, such as 5G communication networks, without restricting the embodiments to such architectures, however. It is obvious for a person skilled in the art that the embodiments may also be applied to other kinds of communication networks having suitable means by adjusting parameters and procedures appropriately, e.g. 4G networks, WiFi, worldwide interoperability for microwave access (WiMAX), Bluetooth®, personal communications services (PCS), ZigBee®, wideband code division multiple access (WCDMA), systems using ultra-wideband (UWB) technology, mobile ad-hoc networks (MANETs), wired access, etc. Furthermore, without loss of generality, the description of some examples of embodiments is related to a mobile communication network in a vertical use case, i.e. a dedicated purpose network, but principles of the invention can be extended and applied to any other type of communication network.

The following examples and embodiments are to be understood only as illustrative examples. Although the specification may refer to “an”, “one”, or “some” example(s) or embodiment(s) in several locations, this does not necessarily mean that each such reference is related to the same example(s) or embodiment(s), or that the feature only applies to a single example or embodiment. Single features of different embodiments may also be combined to provide other embodiments. Furthermore, terms like “comprising” and “including” should be understood as not limiting the described embodiments to consist of only those features that have been mentioned; such examples and embodiments may also contain features, structures, units, modules etc. that have not been specifically mentioned.

A basic system architecture of a (tele)communication network including a mobile communication system where some examples of embodiments are applicable may include an architecture of one or more communication networks including a wired or wireless access network subsystem and a core network. Such an architecture may include one or more communication network control elements, access network elements, radio access network elements, access service network gateways or base transceiver stations, such as a base station (BS), an access point (AP), a NodeB (NB), an eNB or a gNB, a distributed or a centralized unit, which control a respective coverage area or cell(s) and with which one or more communication stations such as communication elements, user devices or terminal devices, like a UE or a vehicle, or another device having a similar function, such as a modem chipset, a chip, a module etc., which can also be part of a station, an element, a function or an application capable of conducting a communication, such as a UE, an element or function usable in a machine-to-machine communication architecture, or attached as a separate element to such an element, function or application capable of conducting a communication, or the like, are capable to communicate via one or more channels for transmitting several types of data in a plurality of access domains. Furthermore, core network elements such as gateway network elements, mobility management entities, a mobile switching center, servers, databases and the like may be included.

The general functions and interconnections of the described elements, which also depend on the actual network type, are known to those skilled in the art and described in corresponding specifications, so that a detailed description thereof is omitted herein. However, it is to be noted that several additional network elements and signaling links may be employed for a communication to or from an element, function or application, like a communication endpoint, a communication network control element, such as a server, a radio network controller, and other elements of the same or other communication networks besides those described in detail herein below.

A communication network as being considered in examples of embodiments may also be able to communicate with other networks, such as a public switched telephone network or the Internet. The communication network may also be able to support the usage of cloud services for virtual network elements or functions thereof, wherein it is to be noted that the virtual network part of the telecommunication network can also be provided by non-cloud resources, e.g. an internal network or the like. It should be appreciated that network elements of an access system, of a core network etc., and/or respective functionalities may be implemented by using any node, host, server, access node or entity etc. being suitable for such a usage.

Furthermore, a network element, such as communication elements, like a UE, a terminal device, control elements or functions, such as access network elements, like a base station (BS), an gNB, a radio network controller, other network elements as well as corresponding functions as described herein, and other elements, functions or applications may be implemented by software, e.g. by a computer program product for a computer, and/or by hardware. For executing their respective functions, correspondingly used devices, nodes, functions or network elements may include several means, modules, units, components, etc. (not shown) which are required for control, processing and/or communication/signaling functionality. Such means, modules, units and components may include, for example, one or more processors or processor units including one or more processing portions for executing instructions and/or programs and/or for processing data, storage or memory units or means for storing instructions, programs and/or data, for serving as a work area of the processor or processing portion and the like (e.g. ROM, RAM, EEPROM, and the like), input or interface means for inputting data and instructions by software (e.g. floppy disc, CD-ROM, EEPROM, and the like), a user interface for providing monitor and manipulation possibilities to a user (e.g. a screen, a keyboard and the like), other interface or means for establishing links and/or connections under the control of the processor unit or portion (e.g. wired and wireless interface means, radio interface means including e.g. an antenna unit or the like, means for forming a radio communication part etc.) and the like, wherein respective means forming an interface, such as a radio communication part, can be also located on a remote site (e.g. a radio head or a radio station etc.). It is to be noted that in the present specification processing portions should not be only considered to represent physical portions of one or more processors, but may also be considered as a logical division of the referred processing tasks performed by one or more processors.

It should be appreciated that according to some examples, a so-called “liquid” or flexible network concept may be employed where the operations and functionalities of a network element, a network function, or of another entity of the network, may be performed in different entities or functions, such as in a node, host or server, in a flexible manner. In other words, a “division of labor” between involved network elements, functions or entities may vary case by case.

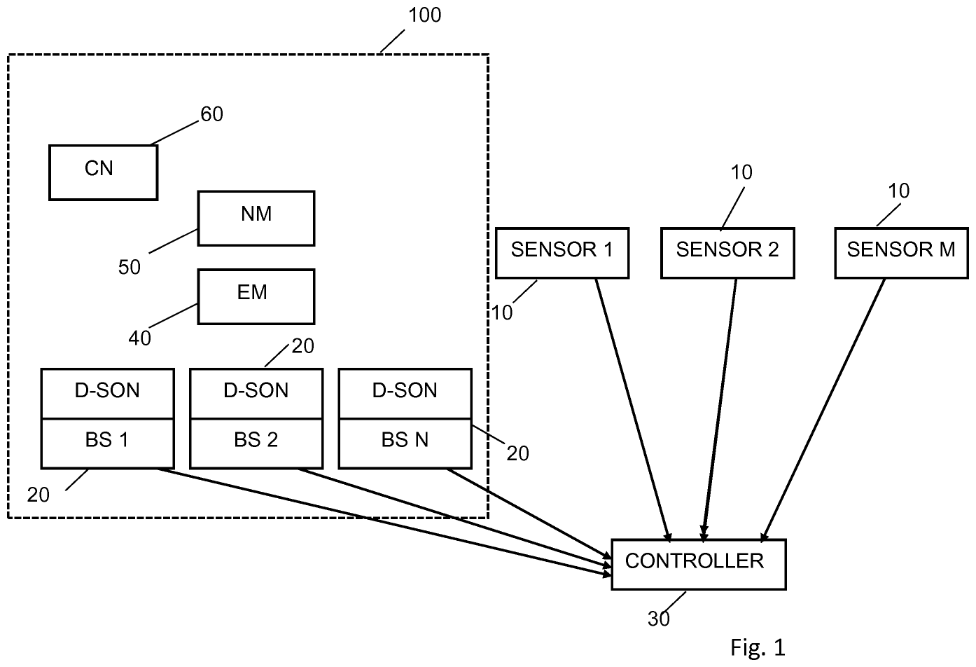

FIG. 1 shows a diagram illustrating a general configuration of a mobile communication network and a system for executing a communication network analysis and management according to some examples of embodiments of the invention.

Reference number 100 denotes a mobile communication network, which represents the target of the network analysis and management processing according to examples of embodiments of the invention. In the example shown in FIG. 1, the mobile communication network 100 is a 5G network in a vertical deployment use case, such as an enterprise deployment. However, as also indicated above, the mobile communication network may be also of another type, wherein the configuration details may be varying.

In the mobile communication network 100, a core network (CN) 60 which includes, for example, registers like home location register and the like, gateways like serving gateway and packet gateways, servers and the like is provided. Furthermore, a network manager (NM) 50 and an element manager 40 are provided.

The EM 40 is used for fault, configuration, accounting, performance and security processing. Portions of each of the FCAPS functionality fit into the TMN models. The EM 40 interfaces to the NM 50 and to communication control elements like base stations. The EM 40 manages functions and capabilities within the communication network and corresponding elements but does not manage the traffic between different network elements in the mobile communication network 100.

The NM 50 conducts a processing for administering and managing the network elements in the mobile communication network 100. The NM 50 is used for fault analysis, performance management, provisioning of network and network resources, maintaining the quality of service, etc.

Reference signs 20 denote one or more base stations (BS) (in the example of FIG. 1, N BS are indicated, wherein N≥1) which are connected to the CN 60. The BS 20 represent examples of communication network control elements or functions of the mobile communication network 100 which are used for communicating with one or more communication elements like UEs (not shown) in the mobile communication network 100. In the example shown in FIG. 1, the BS 20 are related to distributed SON entities. SON is an automation technology designed to make the planning, configuration, management, optimization and healing of the access system of a mobile communication network simpler and faster. D-SON means that functions are distributed among the network elements at the edge of the network which implies a certain degree of localization of functionality.

According to examples of embodiments, the BS 20 are configured to measure and provide so-called performance information which indicates a communication performance in the mobile communication network 100. Furthermore, the BS 20 is aware of configuration settings in the mobile communication network, such as transmission power setting etc., and can provide corresponding configuration information indicating the configuration parameters for the mobile communication network 100.

In the system for network analysis and management according to examples of embodiments of the invention, one or more sensors 10 (in the example of FIG. 1, M sensors are indicated, wherein M≥1) are provided. The sensors 10 can be of the same type or of different types, i.e. measure the same type of parameter or different types of parameters. In any case, the sensors 10 are configured to measure an environmental parameter which is different to a parameter related to the BS 20 (i.e. the measurement of the sensor 10 is related to an environmental parameter being different to a parameter measured by the BS 10). Environmental information indicating a result of the environmental parameter measurement can be provided, i.e. sent by the sensor 10 to an external element. Furthermore, it is also possible that the sensor 10 conducts some sort of processing of the measured parameter, such as an image processing, a filter processing or the like, and provide the processed parameter data as the environmental information.

Sensoric devices which can be employed as the sensor 10 include, for example, any type of sensor which is able to measure environmental characteristics or parameters different to values related to the mobile network performance. For example, sensoric devices like radar, video cameras, infrared cameras, ultrasonic recorders etc. can be used. Correspondingly, the environmental information indicating the result the environmental parameter measurement comprises, for example, still picture data, moving image data, ultrasonic measurement data, radar measurement data, infrared measurement data, and/or analysis results (i.e. processing results) derived from such measurement data.

It is to be noted that sensors 10 being used in the system for network analysis and management according to examples of embodiments can have different resolutions. That is, even within one information domain (e.g. image capturing), the sensoric devices may operate at different level of detail and quality.

Furthermore, the location of the sensors 10 at a deployment site is flexible. For example, sensors of one or more types can be co-located with the BS 10, i.e. placed in the vicinity thereof of even directly at the BS 10. Alternatively or additionally, one or more sensors 10 can be located at any place within the mobile communication network 100, i.e. at places where an effect of anything being detectable by the sensor on the performance of the mobile communication network 100 is expected or is to be monitored. The preferred location of a sensor 10 depends, for example, from the type of sensor, the object or area to be monitored, and the like.

Reference number 30 denotes a control element or function (also referred to as a controller) for executing the network analysis and management according to examples of embodiments. The controller 30 receives and records output information from the sensors 10 and the BS 20, i.e. the environmental information as well as the mobile network performance information and configuration information.

The controller 30 is, for example, a computer based processing device or function which correlates the mobile network performance information with the output of the sensors 10. Based on the derived correlation and by using a decision logic, the controller 30 then predicts an impact of an event sensed by the sensor 10 on the mobile communication network 100, i.e. it predicts a mobile network performance, and decides about measures to be conducted, e.g. measures for pro-actively adapting network parameters or the like.

As shown in FIG. 1, the controller 30 is connected to the sensors 10 and the BS 20. For example, the controller 30 can be a separate element or function provided by a server node or the like, or can be part of the D-SON configuration. For connecting to the respective BS 20 and sensor 10, any suitable interface such as proprietary interfaces, existing interfaces standardized in 3GPP or interfaces specifically standardized for a network analysis and management according to examples of embodiments (e.g. as part of 3GPP specifications) is usable.

In the network analysis and management processing according to examples of embodiments, the controller 30 receives performance information (i.e. mobile network performance measurements) from the individual BS 20, for example information indicating a throughput, a packet loss rate, handover failure events, radio link failure events, radio power receive level, and traffic load. Furthermore, current network configuration parameters such as transmit power, radio resource allocation, handover thresholds, and user allocations to the BS are received.

Furthermore, sensoric data from sensors 10 are received by the controller.

Then the controller 30 performs, on the basis of the received information, a processing for correlating the information in order to determine (analyze) an impact of an event causing the measurement result of the sensor on the communication network, which is reflected by a corresponding decision logic and updates of such decision logic.

For example, in a first phase, a training processing with pre-classified situations is conducted by using actual measurement results. After the training processing has been finished, a classification of the received environmental information based on the mobile network performance measurements and mobile network configuration can be conducted. In the training phase, the controller 30 can use, for example, already recorded sensoric data and mobile network performance data in order to induce a decision logic used for later processing in an operational phase. In this connection, it is to be noted that the training processing can be continued also during the operational phase of the system.

The duration of the training phase can be set in accordance with a predetermined time which is set to be able to emulate a sufficient number of situations which could occur in the mobile communication network and impacting the performance thereof. Alternatively, a number of transmissions of performance information and/or, environmental information can be used as a trigger for completing the training processing.

According to examples of embodiments, the training processing can be conducted either completely automatically or be supported by human intervention. For example, classifying of events due to environmental changes can be adjusted by input of an operator. As an illustrative example, a case of a HOF/RLF due to a moving object in the vicinity of a BS can be assumed; in this case, the human operator may indicate this movement as the event and indicate a suitable counter-measure, such as initiating a handover.

According to some examples of embodiments, the processing for analyzing the impact of environmental parameters (changes) on the performance of the mobile communication network is based on a decision logic, such as a machine learning algorithm. Depending on the complexity of the algorithm or the system to be monitored, the decision logic can be based on e.g. Bayesian classifiers or linear classifiers (e.g. in the case of low-complexity algorithms), or neural networks or decision trees (in the case of more complex algorithms).

For example, in case of Bayesian classifiers, the probability that a change of the environment implies a mobile network performance change is measured based on a-posteriori knowledge. Then, using Bayesians equations, the probability is derived that a change of the environment would imply a change e.g. of the radio conditions or mobile network performance. Based on the derived probability (likelihood of an event), pre-defined measures can be initiated. For example, when a change of the environment is detected from an image sensor output (e.g., “pixel area Y changed to black” or “robot moving to pixel Y”), it is determined that a change of the radio conditions (e.g. “path loss drops by 3 dB”) or mobile network performance (e.g. “Throughput drops by 20%”) occurs, so that a suitable measure for compensating or mitigating this is instructed (e.g. “allocate more bandwidth”).

On the other hand, in case of using e.g. a decision tree, a sequence of “if—then—else” rules are established in order to induce whether a certain change of the environment causes a change e.g. of the mobile network performance. For instance, the decision tree may check whether “robot is moving in pixel area X” and “window Y is closed” and “base station downtilt is larger than 3 degrees” then “strong inter-cell interference from cell Z” is valid.

In the following, based on the configuration of FIG. 1, an implementation example of a network analysis and management processing for a mobile communication network in a factory hall network deployment is described for illustrating aspects of examples of embodiments of the invention.

In such a factory hall network deployment, it is assumed that the BS 20 are e.g. so-called pico cells deployed in the factory hall at suitable places in order to provide mobile network coverage within the whole factory hall. The individual terminals (i.e. UEs) communicating with the BS 20 are either static (i.e. machines used in the production chain) or mobile (e.g. automated guided vehicle (AGV), robots).

In the factory hall, it is assumed that different pieces of equipment are present, such as moving objects (e.g. AGVs, other vehicles etc.), machines being basically static but having movable (e.g. rotating) parts (e.g. motors used for drills, lathes etc.), building parts (windows, doors etc.). These pieces of equipment may have more or less effect on communication conditions of the BS 20, e.g. depending on the location of the equipment, the speed thereof, the characteristics thereof (e.g. a highly reflective surface of the individual machines and robots), i.e. an impact on the network performance can be detected. For example, each moving object may cause changes of the shadowing (slow fading) as well as multi-path setup (fast fading).

By means of the sensors 10, it is possible to detect events which result to changes in the network performance. For example, assuming the sensors 10 are video cameras placed in the factory hall at locations where the vicinity of the BS 20 are monitored. The changes in the environment of the BS 20 leading to a change in the communication performance can be detected by using the video camera, for example, by tracking changes in the different areas of the video image (e.g. categorized by “pixels” which change) or by tracking (i.e. recognizing and following) individual objects (such as an AGV) by using an image recognition algorithm (it is to be noted that the image recognition algorithm can be applied in the sensor 10 itself or in the controller 30, for example).

When a decision logic is set (i.e. learned or trained), the controller 30 is able to predict the impact of an event (e.g. movement of an AGV to a specific place) on the mobile network performance. For example, according to examples of embodiments, the decision parameters in the decision logic can be based on the location of the changes (i.e. where happened the change in an image), the type of recognized object, e.g. is the object being detected one having a high degree of impact (e.g. an AGV) or a low degree of impact (e.g. a human), the shape of the object, the velocity of the object, etc.

Possible classes of the decision logic can be based on the network element being influenced. For example, a class for base stations, a class for UEs or the like can be set. Also classes e.g. for BS having a more critical task and for BS having a less critical task can be set. Alternatively or additionally, classes for required measures which need to be taken can be set.

Based on the class, which has been decided by the decision logic, the controller 30 then decides about measures to be conducted. For example, the controller takes suitable measures for compensating an effect, e.g. by adding additional carriers (carrier aggregation), by proactively changing a MCS, by reserving resource blocks, by preparing a handover, by activating another communication mode (e.g. dual connectivity mode), by initiating load-balancing/cell-breathing algorithms, etc.

As a result, the controller 30 analyzes the situation in the factory hall caused by objects therein by correlating the information from the sensors 10 (i.e. the images) and communication performance information in order to recognize that there is e.g. a critical impact on the communication quality, and takes a measure which allows to avoid such a negative consequence.

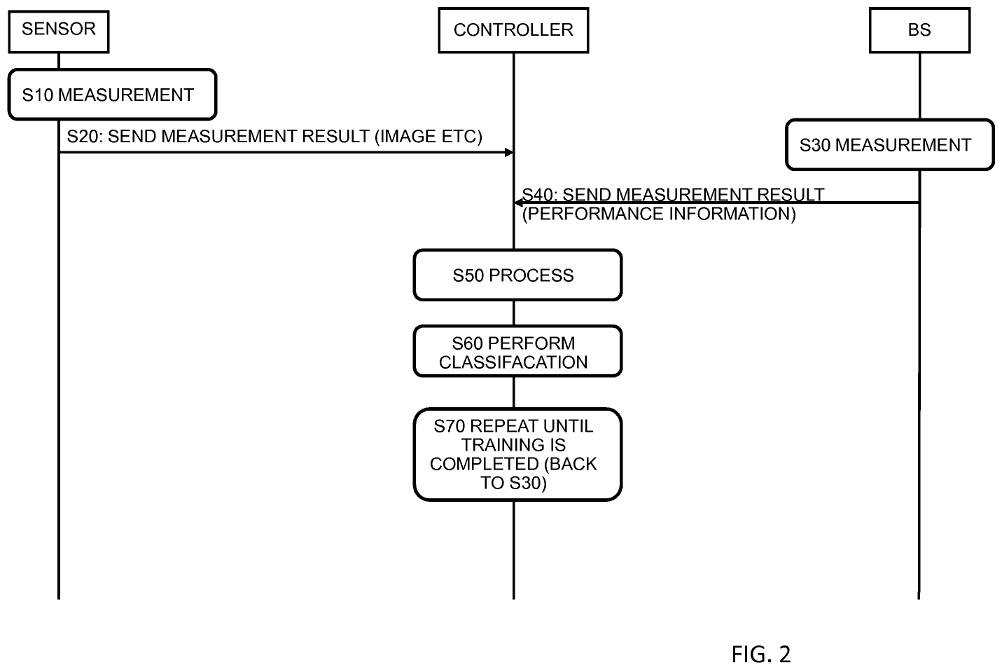

FIG. 2 shows a signaling diagram illustrating an example for a processing being executed in a system for analyzing and managing a communication network according to some examples of embodiments of the invention. Specifically, FIG. 2 illustrates a training processing for a decision logic according to examples of embodiments.

In S10, the sensor 10 conducts corresponding measurements of environmental parameters, wherein in S20 the sensor 10 delivers the recorded information, e.g. an image, to the controller 30. As described above, the sensor 10 may already perform an identification of attributes, e.g., pixel changes, an object detection, etc., wherein such a processing can be also conducted in the controller on the basis of data provided in S20. In the latter case, object detection etc. may be enhanced by considering data from a plurality of sensors, for example.

Furthermore, in S30, the BS 20 conducts corresponding measurements of communication performance, wherein in S40 the BS 20 delivers the recorded information, together with configuration information, to the controller 30.

In S50, by using the image data attributes including the mobile network performance information and the mobile network configuration information, the controller 30 performs a classification processing. Possible classes may relate, for example, to actions that are required (e.g., prepare handover, adjust cell border, etc.) or to possible events that may occur (e.g., potential performance decrease, reduced SNR, increased interference, etc.). The classification is then compared to a correct classification in order to train the learning algorithm on which the decision logic is based. For example, weights and parameters of the algorithm are adjusted.

As shown in S70, the processing is repeated until a sufficient number of training samples have been used (depending on the machine learning algorithm and the number of considered attributes, for example).

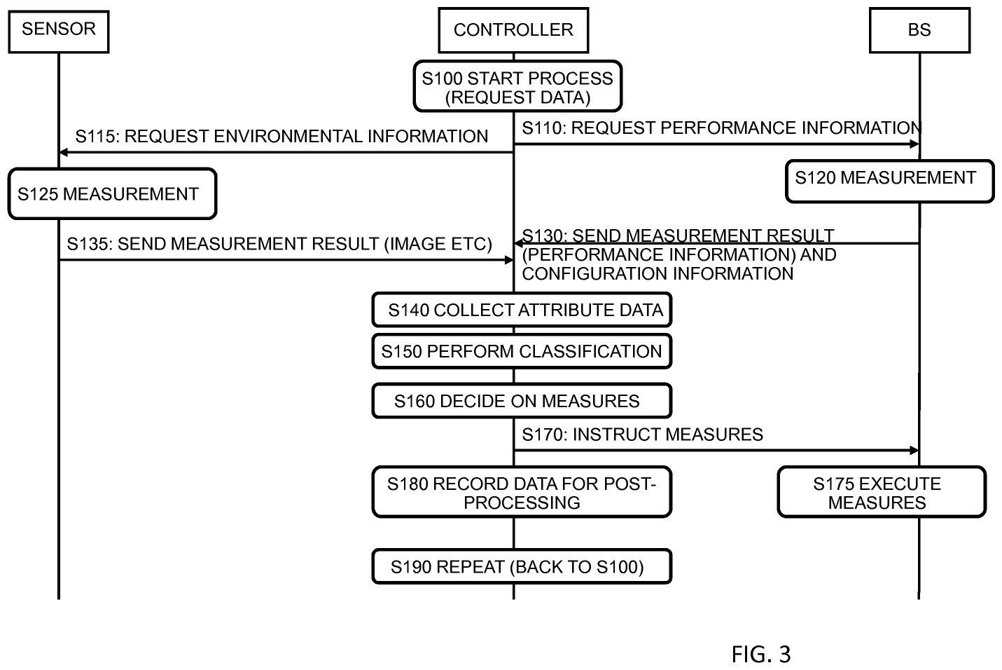

FIG. 3 shows a signaling diagram illustrating an example for a processing being executed in a system for analyzing and managing a communication network according to some examples of embodiments of the invention. Specifically, FIG. 3 illustrates an operational phase using a decision logic according to examples of embodiments. The operational phase illustrated in FIG. 3 can be entered once the training processing in FIG. 2 has been (sufficiently) completed.

In S100, when starting the processing in the operational phase, the controller 30 requests repetitively data. That is, in S115, data are requested from the sensors 10 (i.e. the environmental information), and in S110, data (i.e. the performance information and configuration information) are requested from the BS 20. The sensor 10 conducts corresponding measurements in S125 and sends the results in S135 to the controller 30 as the environmental information (e.g. image data). On the other hand, the BS 20 conducts measurements in S120 and sends the performance information and configuration information to the controller 30 in S130.

In S140, the controller 30 collects these pieces of information (received in S135 and S130) and uses them as attributes for the machine learning decision logic. In S150, the set of attributes derived from the environmental information, the performance information and the configuration information are classified. As a result of the classification, in S160, a decision about measures to be conducted is made. For example, the classification suggests directly corrective actions or indicates potential events that require further attention.

Based on the classification in S150 and in case the processing in S160 results in a decision that e.g. a corrective measure (e.g. add additional communication resources or the like) is required, the BS 20 is instructed in S170 about a corrective measures. In S175, the BS executes this measure of S170.

According to examples of embodiments, in the case that S160 results in an execution of a corrective measure, in S180, information for post-processing are recorded. That is, the attribute data leading to the decision, the corrective measure being selected, as well as data received after the measure has been taken (i.e. performance data or configuration data received from the BS 20 after instructing the execution of the corrective measure in S170) are recorded. The post-processing is conducted, for example, by a human operator. For example, the post-processing is used to monitor the correctness of the machine learning program and to apply adjustments if necessary (e.g. adjusting weights accordingly).

It is to be noted that the system for analyzing and managing a mobile communication network as discussed above with regard to examples of embodiments of the invention is applicable to a variety of network types. For example, the above described system and processing is independent of the type of the communication network control element or function (e.g. base station) being used as long as suitable interfaces for monitoring and configuring the mobile communication network are provided, i.e. an interface through which current configuration parameters and mobile network performance can be read, and an interface, which allows for controlling the base station even on a short timescale. In examples of embodiments of the invention, such interfaces may be standardized in 3GPP. Another option may be interfaces based e.g. on OpenBTS. Alternatively, proprietary interfaces could be used (as are already in place (partly) for EMS).

Furthermore, depending on the actual use case, environment, etc. the described system for analyzing and managing a mobile communication network can be customized. That is, taking into account environmental parameters such as geography (e.g. indoors/outdoors), size (e.g. small area or large campus), surrounding area (e.g. interferers, spectrum usage), surface material (e.g. highly reflective or diffuse), shape of structures and buildings (e.g. very scattered such as pipes or machines), the configuration of the system (i.e. number, type and location of sensors, amount of data considered in the classification etc.) can be varied. For example, the parameters can be taken into account in the design of the learning algorithm and decision logic. For instance, the probabilities of the Bayesian classifiers can be modified (biased) and the decision logic can consider the surrounding environment. The actual customization may be specific to application areas (e.g., harbours, factory campus, indoor factory, office building), specific within industries or even specific for individual deployments.

Furthermore, according to examples of embodiments, the processing for analyzing and managing a mobile communication network can be implemented in a central controller for a network deployed by a vertical, thereby connecting all base stations deployed by the tenant. Alternatively, multiple controllers connecting to only one (or very few) base station may be deployed, taking only a subset of measurements from the sensors into account. In this case, the controller may be even part of the base station itself, e.g. if the sensor is “bundled” with the base station equipment, the controller could be implemented proprietarily as part of the base station. In this case, it is required to train (possibly with human interaction) each controller, wherein it is also necessary to consider actions taken by other controllers into account. For this purpose, for example, a link between the controllers can be established which provides information of measures taken by the controllers. In other words, information provided by another controller and indicating measures being taken by the other controller are input as another form of environmental information. That is, the actions taken by one of the other base stations is seen as an attribute, wherein in this case a corresponding indication from one of the other BS is provided and considered in the correlation process (i.e. the controller related to another BS acts as sensor detecting coming changes of BS behaviour).

FIG. 3 shows a flow chart of a processing conducted in a control element or function configured to execute a communication network analysis and management for a mobile communication network according to some examples of embodiments. Specifically, the example according to FIG. 3 is related to a procedure conducted by a control element or function, such as the controller 30 as shown in connection with FIG. 1.

In S200, performance information indicating a communication performance in the mobile communication network measured at at least one communication network control element or function (such as one or more of the BS 20 in FIG. 1), is received from the at least one communication network control element or function of the mobile communication network. The performance information is stored.

According to some examples of embodiments, the performance information indicating the communication performance in the mobile communication network is related to at least one of a throughput at a communication network control element or function of the communication network (e.g. the BS 20), a packet loss rate, a handover failure, a radio link failure, a radio power receive level, and a traffic load.

In S210, configuration information indicating configuration parameters for the mobile communication network is received and stored.

According to some examples of embodiments, the configuration information indicating the configuration parameters for the communication network is related to at least one of a transmit power used for a communication with the communication network control element or function, a radio resource allocation, a handover threshold, a number of user allocations to the communication network control element or function, and a type of user allocations to the communication network control element or function.

In S220, environmental information indicating a result of an environmental parameter measurement of at least one sensor configured to measure an environmental parameter is received and stored. The environmental parameter measurement is different to a measurement conducted by the at least one communication network control element or function.

According to some examples of embodiments, the environmental information indicating the result of an environmental parameter measurement comprises at least one of still picture data, moving image data, ultrasonic measurement data, radar measurement data, infrared measurement data, and measurement data analysis results.

In S230, a processing for correlating the performance information, the configuration information and the environmental information is conducted for analyzing an impact of the environmental parameter on the communication performance in the mobile communication network. In other words, the environmental information is analyzed so as to determine whether there is an impact on the communication performance of the mobile communication network.

For example, according to some examples of embodiments, the processing for correlating the performance information, the configuration information and the environmental information for analyzing the impact of the environmental parameter on the communication performance in the mobile communication network is based on a machine learned decision logic for predicting an effect of an environmental parameter or a change of an environmental parameter on the communication performance in the mobile communication network, wherein the machine learned decision logic is based on at least one of a Bayesian classifier, a linear classifier, a decision tree and a neural network.

According to some examples of embodiments, in the processing based on the decision logic, at least one decision parameter in the decision logic is set on the basis of an analysis of the environmental information. Then, a set of attributes derived from the performance information, the configuration information and the environmental information is classified in accordance with the at least one decision parameter (i.e. a classification of the attributes is made), and a measure to be conducted in the mobile communication network for modifying a setting of the mobile communication network is determined on the basis of the classification.

Moreover, according to some examples of embodiments, a training processing for adjusting the decision logic is executed, wherein the training processing includes receiving performance information, configuration information and environmental information, classifying a set of training attributes derived from the received performance information, configuration information and environmental information (i.e. the information received in the training processing). Then, the result of the classifying of the training attributes is compared with pre-stored data (i.e. already known information). On the basis of the comparison, settings of the decision logic (i.e. weights and parameters of used algorithms) are adjusted. The training processing is conducted for at least one of a predetermined time, a predetermined number of performance information, and a predetermined number of environmental information. Furthermore, the decision logic resulting from the training processing is used for an operation of the apparatus.

According to some further examples of embodiments, the classifying is related to at least one of an action to be required (i.e. measures to be conducted in the mobile communication network) or an event which potentially occurs in the mobile communication network.

In S240, on the basis of a result of the processing for correlating, a decision is made about at least one measure to be conducted in the mobile communication network for modifying a setting of the mobile communication network.

According to some further examples of embodiments, in the decision processing, as the measure to be conducted in the mobile communication network for modifying the setting of the mobile communication network, a measure is selected which is assumed to compensate or mitigate an effect of the environmental parameter on the communication performance of the mobile communication network. According to some examples of embodiments, the measure to be conducted includes at least one of adding additional communication resources to the communication, reserving additional communication resources for the communication, modifying a modulation and coding scheme used in the communication, preparing or instructing a handover of a communication element in the mobile communication unit, changing a communication mode used for the communication (e.g. dual connectivity mode), and starting load balancing or cell breathing algorithms for the communication.

According to some further examples of embodiments, when it is decided to conduct at least one measure in the mobile communication network for modifying a setting of the mobile communication network, information about the performance information, the configuration information and the environmental information used in the processing for correlating, the decided measure to be conducted and performance information received after the measure to be conducted is effected, are recorded (for a post-processing of the analysis and management processing).

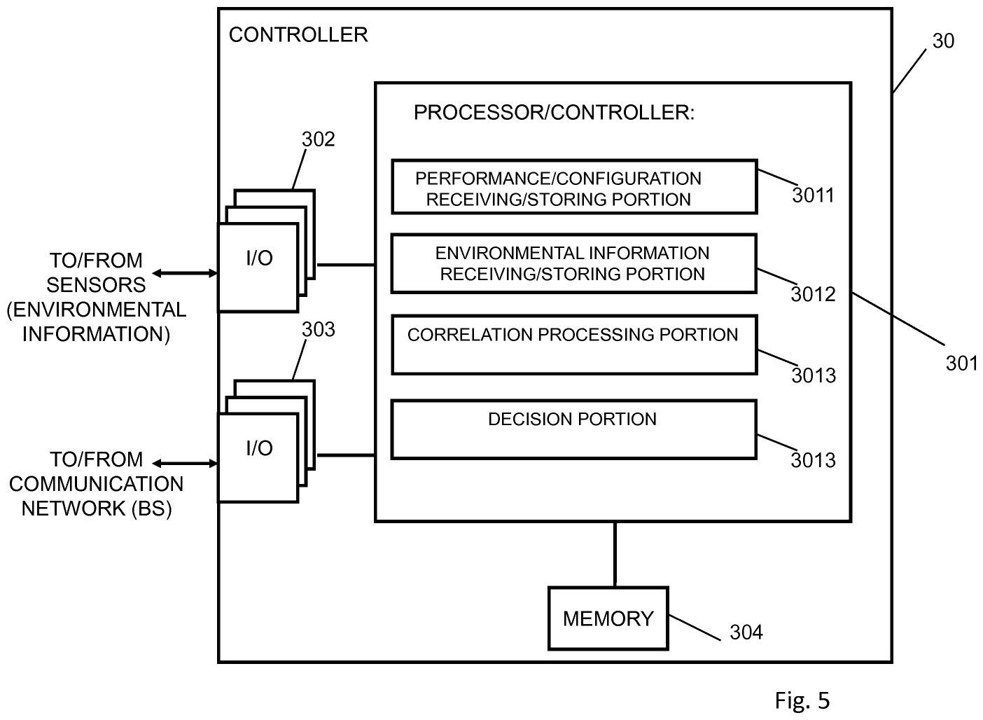

FIG. 5 shows a diagram of a control element or function configured to execute a communication network analysis and management according to some examples of embodiments, e.g. as the controller 30, which is configured to implement a procedure for a network analysis and management processing as described in connection with some of the examples of embodiments. It is to be noted that the control element or function, like the controller 30 of FIG. 1, may include further elements or functions besides those described herein below. Furthermore, even though reference is made to a network element or function, the element or function may be also another device or function having a similar task, such as a chipset, a chip, a module, an application etc., which can also be part of a network element or attached as a separate element to a network element, or the like. It should be understood that each block and any combination thereof may be implemented by various means or their combinations, such as hardware, software, firmware, one or more processors and/or circuitry.

The control element 30 shown in FIG. 5 may include a processing circuitry, a processing function, a control unit or a processor 301, such as a CPU or the like, which is suitable for executing instructions given by programs or the like related to the control procedure. The processor 301 may include one or more processing portions or functions dedicated to specific processing as described below, or the processing may be run in a single processor or processing function. Portions for executing such specific processing may be also provided as discrete elements or within one or more further processors, processing functions or processing portions, such as in one physical processor like a CPU or in one or more physical or virtual entities, for example. Reference sign 302 and 303 denotes input/output (I/O) units or functions (interfaces) connected to the processor or processing function 301. The I/O units 302 may be used for communicating with environmental sensors like sensors 10, as described in connection with FIG. 1, for example. The I/O units 303 may be used for communicating with the mobile communication network like the BS 20, as described in connection with FIG. 1, for example. The I/O units 302 and 303 may be a combined unit including communication equipment towards several entities, or may include a distributed structure with a plurality of different interfaces for different entities. Reference sign 304 denotes a memory usable, for example, for storing data and programs to be executed by the processor or processing function 301 and/or as a working storage of the processor or processing function 301. It is to be noted that the memory 304 may be implemented by using one or more memory portions of the same or different type of memory.

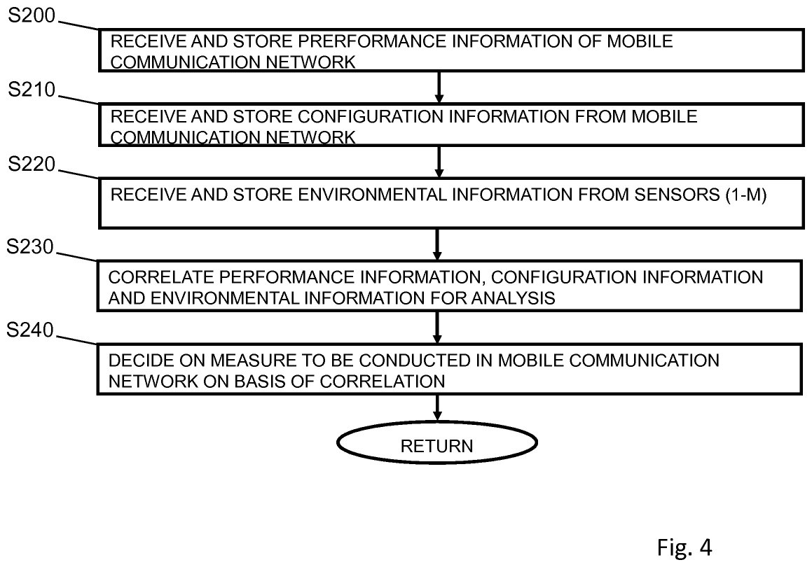

The processor or processing function 301 is configured to execute processing related to the above described network analysis and management processing. In particular, the processor or processing circuitry or function 301 includes one or more of the following sub-portions. Sub-portion 3011 is a processing portion which is usable as a portion for receiving and storing performance information and configuration information from the communication network. The portion 3011 may be configured to perform processing according to S200 and S210 of FIG. 4. Furthermore, the processor or processing circuitry or function 301 may include a sub-portion 3012 usable as a portion for receiving and storing environmental information from the sensors. The portion 3012 may be configured to perform a processing according to S220 of FIG. 4. In addition, the processor or processing circuitry or function 301 may include a sub-portion 3013 usable as a portion for conducting a correlation processing of the performance information, the configuration information and the environmental information. The portion 3013 may be configured to perform a processing according to S230 of FIG. 4. Moreover, the processor or processing circuitry or function 301 may include a sub-portion 3014 usable as a portion for deciding on a measure to be conducted in the mobile communication network. The portion 3014 may be configured to perform a processing according to S240 of FIG. 4.

It is to be noted that examples of embodiments of the invention are applicable to various different network configurations. In other words, the example shown in FIG. 1, which is used as a basis for the above discussed examples, is only illustrative and does not limit the present invention in any way. That is, additional further existing and proposed new functionalities available in a corresponding operating environment may be used in connection with examples of embodiments of the invention based on the principles defined.

According to a further example of embodiments, there is provided, for example, an apparatus for use by a control element or function configured to execute a communication network analysis and management, the apparatus comprising means configured to receive, from at least one communication network control element or function of a mobile communication network, and store performance information indicating a communication performance in the mobile communication network measured at the at least one communication network control element or function, means configured to receive and store configuration information indicating configuration parameters for the mobile communication network, means configured to receive, from at least one sensor configured to measure an environmental parameter, and store environmental information indicating a result of an environmental parameter measurement, the environmental parameter measurement being different to a measurement conducted by the at least one communication network control element or function, means configured to conduct a processing for correlating the performance information, the configuration information and the environmental information for analyzing an impact of the environmental parameter on the communication performance in the mobile communication network, and means configured to decide, on the basis of a result of the processing for correlating, about at least one measure to be conducted in the mobile communication network for modifying a setting of the mobile communication network.

Furthermore, according to some other examples of embodiments, the above defined apparatus may further comprise means for conducting at least one of the processing defined in the above described methods, for example a method according that described in connection with FIG. 4.

It should be appreciated that
an access technology via which traffic is transferred to and from an entity in the communication network may be any suitable present or future technology, such as WLAN (Wireless Local Access Network), WiMAX (Worldwide Interoperability for Microwave Access), LTE, LTE-A, 5G, Bluetooth, Infrared, and the like may be used; additionally, embodiments may also apply wired technologies, e.g. IP based access technologies like cable networks or fixed lines.
embodiments suitable to be implemented as software code or portions of it and being run using a processor or processing function are software code independent and can be specified using any known or future developed programming language, such as a high-level programming language, such as objective-C, C, C++, C #, Java, Python, Javascript, other scripting languages etc., or a low-level programming language, such as a machine language, or an assembler.
implementation of embodiments is hardware independent and may be implemented using any known or future developed hardware technology or any hybrids of these, such as a microprocessor or CPU (Central Processing Unit), MOS (Metal Oxide Semiconductor), CMOS (Complementary MOS), BiMOS (Bipolar MOS), BiCMOS (Bipolar CMOS), ECL (Emitter Coupled Logic), and/or TTL (Transistor-Transistor Logic).
embodiments may be implemented as individual devices, apparatuses, units, means or functions, or in a distributed fashion, for example, one or more processors or processing functions may be used or shared in the processing, or one or more processing sections or processing portions may be used and shared in the processing, wherein one physical processor or more than one physical processor may be used for implementing one or more processing portions dedicated to specific processing as described,
an apparatus may be implemented by a semiconductor chip, a chipset, or a (hardware) module including such chip or chipset;
embodiments may also be implemented as any combination of hardware and software, such as ASIC (Application Specific IC (Integrated Circuit)) components, FPGA (Field-programmable Gate Arrays) or CPLD (Complex Programmable Logic Device) components or DSP (Digital Signal Processor) components.
embodiments may also be implemented as computer program products, including a computer usable medium having a computer readable program code embodied therein, the computer readable program code adapted to execute a process as described in embodiments, wherein the computer usable medium may be a non-transitory medium.

Although the present invention has been described herein before with reference to particular embodiments thereof, the present invention is not limited thereto and various modifications can be made thereto.

1-22. (canceled)

23. An apparatus for use by a control element or function configured to execute a communication network analysis and management, the apparatus comprising
at least one processing circuitry, and
at least one memory for storing instructions to be executed by the processing circuitry,
wherein the at least one memory and the instructions are configured to, with the at least one processing circuitry, cause the apparatus at least:
to receive, from at least one communication network control element or function of a mobile communication network, and store performance information indicating a communication performance in the mobile communication network measured at the at least one communication network control element or function,
to receive and store configuration information indicating configuration parameters for the mobile communication network,
to receive, from at least one sensor configured to measure an environmental parameter, and store environmental information indicating a result of an environmental parameter measurement, the environmental parameter measurement being different to a measurement conducted by the at least one communication network control element or function,
to conduct a processing for correlating the performance information, the configuration information and the environmental information for analyzing an impact of the environmental parameter on the communication performance in the mobile communication network, and
to decide, on the basis of a result of the processing for correlating, about at least one measure to be conducted in the mobile communication network for modifying a setting of the mobile communication network.

24. The apparatus according to claim 23, wherein
the performance information indicating the communication performance in the mobile communication network is related to at least one of
a throughput at a communication network control element or function of the communication network, a packet loss rate, a handover failure, a radio link failure, a radio power receive level, and a traffic load, and
the configuration information indicating the configuration parameters for the communication network is related to at least one of
a transmit power used for a communication with the communication network control element or function, a radio resource allocation, a handover threshold, a number of user allocations to the communication network control element or function, and a type of user allocations to the communication network control element or function.

25. The apparatus according to claim 23, wherein
the environmental information indicating the result of an environmental parameter measurement comprises at least one of
still picture data, moving image data, ultrasonic measurement data, radar measurement data, infrared measurement data, and measurement data analysis results.

26. The apparatus according to claim 23, wherein the processing for correlating the performance information, the configuration information and the environmental information for analyzing the impact of the environmental parameter on the communication performance in the mobile communication network is based on a machine learned decision logic for predicting an effect of an environmental parameter or a change of an environmental parameter on the communication performance in the mobile communication network, wherein the machine learned decision logic is based on at least one of
a Bayesian classifier, a linear classifier, a decision tree and a neural network.

27. The apparatus according to claim 26, wherein the at least one memory and the instructions are further configured to, with the at least one processing circuitry, cause the apparatus at least:
to set at least one decision parameter in the decision logic on the basis of an analysis of the environmental information,
to classify a set of attributes derived from the performance information, the configuration information and the environmental information in accordance with the at least one decision parameter, and
to determine a measure to be conducted in the mobile communication network for modifying a setting of the mobile communication network on the basis of the classification.

28. The apparatus according to claim 26, wherein the at least one memory and the instructions are further configured to, with the at least one processing circuitry, cause the apparatus at least:
to execute a training processing for adjusting the decision logic, wherein the training processing includes:
receiving performance information, configuration information and environmental information,
classifying a set of training attributes derived from the received performance information, configuration information and environmental information,
comparing the result of the classifying of training attributes with pre-stored data, and
adjusting settings of the decision logic on the basis of the comparison,
wherein the training processing is conducted for at least one of
a predetermined time, a predetermined number of performance information, and a predetermined number of environmental information,
and
wherein the decision logic resulting from the training processing is used for an operation of the apparatus.

29. The apparatus according to claim 26, wherein the classifying is related to at least one of an action to be required in the mobile communication network or an event which potentially occurs in the mobile communication network.

30. The apparatus according to claim 23, wherein the at least one memory and the instructions are further configured to, with the at least one processing circuitry, cause the apparatus at least:
to select, as the measure to be conducted in the mobile communication network for modifying the setting of the mobile communication network, a measure which is assumed to compensate or mitigate an effect of the environmental parameter on the communication performance of the mobile communication network, wherein the measure to be conducted includes at least one of adding additional communication resources to the communication, reserving additional communication resources for the communication, modifying a modulation and coding scheme used in the communication, preparing or instructing a handover of a communication element in the mobile communication unit, changing a communication mode used for the communication, and starting load balancing or cell breathing algorithms for the communication.

31. The apparatus according to claim 23, wherein the at least one memory and the instructions are further configured to, with the at least one processing circuitry, cause the apparatus at least:
to record, when it is decided to conduct at least one measure in the mobile communication network for modifying a setting of the mobile communication network, information about the performance information, the configuration information, the environmental information used in the processing for correlating, the decided measure to be conducted and performance information received after the measure to be conducted is effected.

32. A method for use by a control element or function configured to execute a communication network analysis and management, the method comprising
receiving, from at least one communication network control element or function of a mobile communication network, and storing performance information indicating a communication performance in the mobile communication network measured at the at least one communication network control element or function,
receiving and storing configuration information indicating configuration parameters for the mobile communication network,
receiving, from at least one sensor configured to measure an environmental parameter, and storing environmental information indicating a result of an environmental parameter measurement, the environmental parameter measurement being different to a measurement conducted by the at least one communication network control element or function,
conducting a processing for correlating the performance information, the configuration information and the environmental information for analyzing an impact of the environmental parameter on the communication performance in the mobile communication network, and
deciding, on the basis of a result of the processing for correlating, about at least one measure to be conducted in the mobile communication network for modifying a setting of the mobile communication network.

33. The method according to claim 32, wherein
the performance information indicating the communication performance in the mobile communication network is related to at least one of
a throughput at a communication network control element or function of the communication network, a packet loss rate, a handover failure, a radio link failure, a radio power receive level, and a traffic load, and
the configuration information indicating the configuration parameters for the communication network is related to at least one of
a transmit power used for a communication with the communication network control element or function, a radio resource allocation, a handover threshold, a number of user allocations to the communication network control element or function, and a type of user allocations to the communication network control element or function.

34. The method according to claim 32, wherein
the environmental information indicating the result of an environmental parameter measurement comprises at least one of
still picture data, moving image data, ultrasonic measurement data, radar measurement data, infrared measurement data, and measurement data analysis results.

35. The method according to claim 32, wherein the processing for correlating the performance information, the configuration information and the environmental information for analyzing the impact of the environmental parameter on the communication performance in the mobile communication network is based on a machine learned decision logic for predicting an effect of an environmental parameter or a change of an environmental parameter on the communication performance in the mobile communication network, wherein the machine learned decision logic is based on at least one of
a Bayesian classifier, a linear classifier, a decision tree and a neural network.

36. The method according to claim 35, further comprising
setting at least one decision parameter in the decision logic on the basis of an analysis of the environmental information,
classifying a set of attributes derived from the performance information, the configuration information and the environmental information in accordance with the at least one decision parameter, and
determining a measure to be conducted in the mobile communication network for modifying a setting of the mobile communication network on the basis of the classification.

37. The method according to claim 35, further comprising
executing a training processing for adjusting the decision logic, wherein the training processing includes:
receiving performance information, configuration information and environmental information,
classifying a set of training attributes derived from the received performance information, configuration information and environmental information,
comparing the result of the classifying of training attributes with pre-stored data, and
adjusting settings of the decision logic on the basis of the comparison,
wherein the training processing is conducted for at least one of
a predetermined time, a predetermined number of performance information, and a predetermined number of environmental information,
and
wherein the decision logic resulting from the training processing is used for an operation of the apparatus.

38. The method according to claim 32, further comprising
selecting, as the measure to be conducted in the mobile communication network for modifying the setting of the mobile communication network, a measure which is assumed to compensate or mitigate an effect of the environmental parameter on the communication performance of the mobile communication network, wherein the measure to be conducted includes at least one of adding additional communication resources to the communication, reserving additional communication resources for the communication, modifying a modulation and coding scheme used in the communication, preparing or instructing a handover of a communication element in the mobile communication unit, changing a communication mode used for the communication, and starting load balancing or cell breathing algorithms for the communication.

39. The method according to claim 32, further comprising
recording, when it is decided to conduct at least one measure in the mobile communication network for modifying a setting of the mobile communication network, information about the performance information, the configuration information, the environmental information used in the processing for correlating, the decided measure to be conducted and performance information received after the measure to be conducted is effected.

40. A system for executing a communication network analysis and management, the system comprising
at least one communication network control element or function of a mobile communication network, being configured to measure and provide performance information indicating a communication performance in the mobile communication network and to obtain and provide configuration information indicating configuration parameters for the mobile communication network,
at least one sensor configured to measure an environmental parameter and to provide environmental information indicating a result of an environmental parameter measurement, the environmental parameter measurement being different to a measurement conducted by the at least one communication network control element or function,
and an apparatus for use by a control element or function configured to execute the communication network analysis and management.

41. The system according to claim 40, wherein
the at least one sensor is configured to provide, as the environmental information indicating the result of an environmental parameter measurement, at least one of
still picture data, moving image data, ultrasonic measurement data, radar measurement data, infrared measurement data, and measurement data analysis results.
